(19) United States
(12) Patent Application Publication
(10) Pub. No.: US 2014/0167538 A1
(43) Pub. Date: Jun. 19, 2014

(54) ELECTRONIC ENGINE

(71) Applicant: Keila Bentin, Ashkelon (IL)

(72) Inventor: Keila Bentin, Ashkelon (IL)

(21) Appl. No.: 14/022,268

(22) Filed: Sep. 10, 2013

(30) Foreign Application Priority Data
Sep. 12, 2012 (IL) 221913

(51) Int. Cl. H02K 3/28; H02K 16/04; H02K 1/22

(52) U.S. Cl. CPC H02K 3/28; H02K 1/22; H02K 16/04
USPC 310/71; 310/68 R; 310/177

(57) ABSTRACT

The present invention provides embodiments of more efficient electric motors. Disclosed herein is an embodiment of an electric motor having a stator and a rotor, each of which have at least two electromagnets. The polarization of the electromagnets may be changed in a way to reduce self-induction. The electric may include two voltage sources connected in series such that they initiate a rotation cycle of the rotor and only one of the voltage sources drives the rotor for the majority of the rotation cycle. Disclosed also is an embodiment of an electromagnet that has a coil wire structure including a plurality of coil wires, an iron structure; and paramagnetic material that separates (1) the coil wire structure from the iron structure and (2) segments of the coil wires from each other. Also disclosed is a method for producing mechanical energy of rotation using electromagnetic energy

### RELATED APPLICATION

This application claims priority under 35 U.S.C. §119(a) to Israel Patent Application No. 221913, filed Sep. 12, 2012, which is hereby incorporated by reference in its entirety.

### FIELD

The invention relates to an electric motor able to produce mechanical energy of rotation by using opposing magnetic forces. The forces come from magnetic fields produced by a plurality of electromagnets. The electromagnets are arranged on stators and rotor which, according to embodiments of the invention, change polarization from north-south to south-north as needed.

### BACKGROUND

Typically, conventional electric motors use electrical power to produce mechanical power based on two magnetic fields, one which acts on the coil of a rotor, and one which acts within permanent magnets that are positioned in the periphery of a stator.

Electric motors generally are efficient due to very small losses. The reasons which enable the electric motors to work close to 100% efficiency are the following:

a1) magnetic fields created in the rotor and stator are of equal energy and function based on the principle of “action and reaction.”

a2) the electric energy level needed for the activity of the stator electromagnets represents only a small percentage of the electric energy level needed for the activity of the rotor.

a3) it takes advantage of the natural magnetic field present inside iron, which is used as an energy source which contributes to rotation of the rotor.

a4) in these machines, it is possible to obtain 50% of the required energy from the natural energy of the iron and therefore the electric motor is more effective.

a5) electric motors which do not use the natural magnetic source of iron, work with an efficiency which is below 50%.

### SUMMARY

In one aspect, the invention relates to a electric motor comprising:

a stator provided with at least two electromagnets; and a rotor provided with at least two electromagnets.

Advantageously, a change in polarization of the electromagnets, from north-south to south-north or from south-north to north-south, is not accompanied by a self-induction dangerous phenomena, or the phenomena is reduced or minimal.

In one embodiment of the invention, each electromagnet includes:

a plurality of coil wires, an iron structure and paramagnetic material separating at least segments of the wire from each other. In a further embodiment of the invention, paramagnetic material separates the coil wire structure from the iron structure.

In one embodiment of the invention, the paramagnetic material is comprised of aluminum.

In one embodiment of the invention, the electric motor further comprises two voltage sources connected in series.

In certain embodiments of the invention, the series connected voltages sources are arranged to drive together a small part of the rotation cycle of the rotor and wherein only one of the voltage sources is arranged to drive the majority of the rotation cycle.

In one embodiment of the invention, the electric motor further comprises diodes positioned in an electrical path or circuit connecting the leads to a positive terminal of the voltage source so that the return back of electricity to the positive terminal is prevented.

In one embodiment of the invention, the electric motor comprises:

a first electrical path or circuit connecting the leads to one polarity of the at least two electromagnets of the stator;

a second electrical path or circuit connecting the leads to the other polarity of the at least two electromagnets of the stator;

a third electrical path or circuit connecting the leads to the one polarity of the at least two electromagnets of the rotor; and

a fourth electrical path or circuit connecting the leads to the other polarity of the at least two electromagnets of the rotor.

The electric motor can comprise two stators and a rotor, two rotors and three stators; three rotors and four stators; or four rotors and five stators.

The electric motor can comprise four electromagnets on the rotor and eight on the stator; six electromagnets on the rotor and twelve on the stator; or eight electromagnets on the rotor and sixteen on the stator.

In another aspect, the invention relates to an electromagnet including:

a plurality of coil wires; an iron structure; and paramagnetic material separating segments of the wire from each other. Paramagnetic material can separate the coil wires from the iron structure.

In a further aspect, the invention provides a electric motor comprising an electromagnet of the invention.

Also, the invention provides a electric motor characterized in that it comprises a rotor and a stator each provided with at least two electromagnets wherein the electric motor uses electromagnetic energy from the electromagnets in order to produce mechanic energy of rotation.

Surprisingly, it was found according to the invention that the electromagnet special arrangement reduces or minimizes the dangerous phenomena of self-induction inside electric circuits, where coils are present.

In one embodiment of the invention, the electromagnet is characterized in that it includes an iron structure comprising a plurality of iron sheets (e.g. electro-technical iron sheets) arranged to allow magnetization in axial direction; a coil structure comprising a plurality of coil wires wherein paramagnetic material separates at least segments of the wire from each other.

In one embodiment of the invention, the iron structure and the electrical coils (or the coil structure) are accommodated into a housing or carcass cavity, wherein the carcass is comprised of paramagnetic material.

In one embodiment of the invention, the coil wires are made of cuprum.

In one embodiment of the invention, the paramagnetic material is aluminum.

In one embodiment of the invention, the electric motor further comprises two voltage sources connected in series. In a further embodiment, the voltage sources are arranged to initiate the cycle of rotation of the rotor whereas only one of the voltage sources is arranged to drive the majority or remaining of the cycle of rotation.

In one embodiment of the invention, the electrical path that supplies current into the coils (e.g. 40b) and electrical path that transfers current back from the coils (e.g. 41b) of electromagnets of the stator are arranged in pairs.

In one embodiment of the invention, the electrical path that supplies current into the coils (e.g. 40a) and electrical path that transfers current back from the coils (e.g. 41a) of electromagnets of the second stator are arranged in pairs.

In one embodiment of the invention, the electrical path that supplies current into the coils (e.g. 40a) and electrical path that transfers current back from the coils (e.g. 41a) of electromagnets of the rotor are arranged in pairs.

In one embodiment of the invention, suitable diodes are positioned in an electrical path leading to a positive terminal of the voltage source so that the return back of any kind of electricity to the positive terminal is prevented.

In one embodiment of the invention, every half rotation of the axis, polarization changes only in the electromagnets of the rotor whereas in the stators, the polarization remains the same.

The electric motor can comprise a rotor and two stators, two rotors and three stators; three rotors and four stators; or four rotors and five stators.

The electric motor can comprise four electromagnets on the rotor and eight on the stator; six electromagnets on the rotor and twelve on the stator; or eight electromagnets on the rotor and sixteen on the stator.

Also, the invention provides an electromagnet characterized in that it includes a pack of electro-technical iron sheets having certain profile assembled inside of carcass made of a paramagnetic material.

In one embodiment of the invention, the electromagnet further comprises electric coil wires assembled inside a carcass made of paramagnetic material.

In one embodiment of the invention, between the coil wires are positioned sheets of paramagnetic material.

In one embodiment of the invention, the coil wires are made of cuprum.

In one embodiment of the invention, the paramagnetic material is comprised of aluminum.

In another aspect, the invention provides a method for producing mechanic energy of rotation, principally, using electromagnetic energy comprising the steps of:

providing two stators each with at least two electromagnets; and a rotor with at least two electromagnets, providing two voltage sources connected in series, providing electric path for supplying current from the voltage sources to the electromagnets and driving current back from the electromagnets, and energizing the electromagnets and creating antagonistic polarization of the electromagnets of stators and rotor using the electric sources energy.

In one embodiment of the invention, the polarization of the electromagnets of the rotor change every half rotation of a cycle, the series connected voltages sources are arranged to initiate a rotation cycle of the rotor and only one of the voltage sources is arranged to drive the majority of the rotation cycle, and the change in polarization is not accompanied by self induction phenomena or wherein the phenomena is reduced or minimal.

Advantageously, producing magnetic field from a plurality of electromagnets enables huge savings of electric energy.

### BRIEF DESCRIPTION OF THE DRAWINGS

FIG. 1 illustrates a longitudinal section view of part of the electric motor according to one embodiment of the invention, which includes stator-rotor elements.

FIG. 2 illustrates a cross section view of the rotor of the electric motor according to one embodiment of the invention.

FIG. 3 left illustrates electric motor covers 20, 18 and 14, 15; and right illustrates collectors and electrical circuits included in the electric motor according to one embodiment of the invention.

FIG. 4 illustrates electric circuits and electrical sources included in the electric motor according to one embodiment of the invention.

FIG. 5 illustrates an assembly of electromagnet parts according to one embodiment of the invention

FIG. 6 illustrates an assembly of electromagnet parts according to one embodiment of the invention.

### DETAILED DESCRIPTION

One objective of the invention is to provide a electric motor which eliminates the need of producing magnetic fields inside a common coil. The production of the magnetic field inside the coil is exchanged by production of magnetic field by a plurality of electromagnets. The electromagnets according to the invention are assembled in such a special way, so that in the rotors and in the stators of the machine will work only magnetic fields derived from the plurality of electromagnets. Of note, producing magnetic field from a plurality of electromagnets enables huge savings of electric energy.

It is well documented in physics textbooks that electromagnetic induction phenomena occurs inside electric circuits, where coils are present. This phenomenon is also known as self induction or auto induction. When an electric variable field appears in the form of rotation+energy, it creates contra-electromotor power [V] which works against the electric source resulting in a delay of the time needed for the electrical current to increase from intensity−0 to the required intensity [Intensity 0 I=0(A) to intensity AMP required]. This delay is known as electromagnetic inertia phenomena. This phenomena increase with the increase of electric coils winding, and with the increase of the volume [dm³] of the iron. This situation of increased electromagnetic inertia results in an intolerable thousand-time delay as compared to the appropriate time needed for a machine to work properly.

The structure and mode of operation of the electric motor of the present invention allows solving satisfactorily the problem of electromagnetic inertia by one or more of the following approaches:

B1 by reducing to the minimum the effect of the variable electric field in the coils of the electromagnets (of note, this variable electric field typically appears in the electromagnetic coils when the electric current increases and also when the electric current decreases).

B2 by reducing to the minimum the electric current autoindush (which typically appears when the electric current increases and also when the electric current decreases).

B3 by increasing the velocity of the variation of the electric current di/dt [Amp/sec], related to in point B1, by increasing the factor −e/L [Amp/sec]=di/dt [Amp/sec]. In other words, this is a practical method for increasing the factor of contra electromotor force of induction −e[v].

B4 by solving the problem of turbulent current which typically appears when flux of magnetic variable conditions is present.

B5 by decreasing or removing the activities of electro-motor forces of mutual induction.

B6 by using an efficient method of flow (or transfer) and distribution of the electrical current from the electric source to the electrical coils and back from the coils to the continuous electric current source in a synchronous and defined way.

B7 by a method of assembly that allows obtaining a electric motor which enables obtaining an adequate mechanic power [kw], and a desirable volume and weight (Kg).

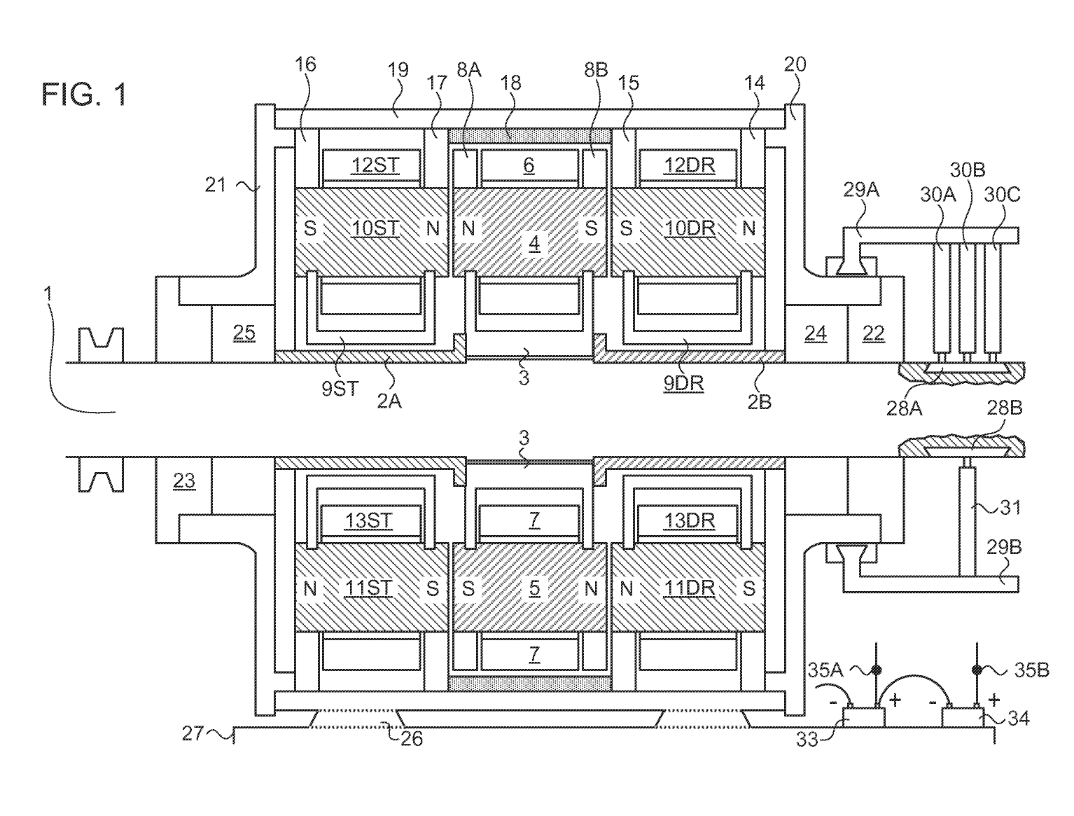

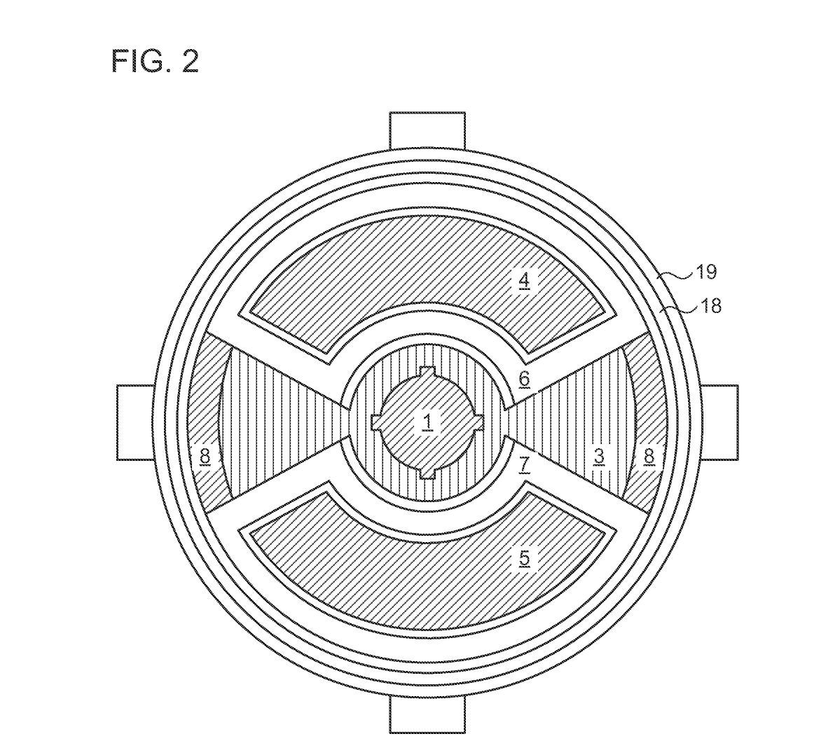

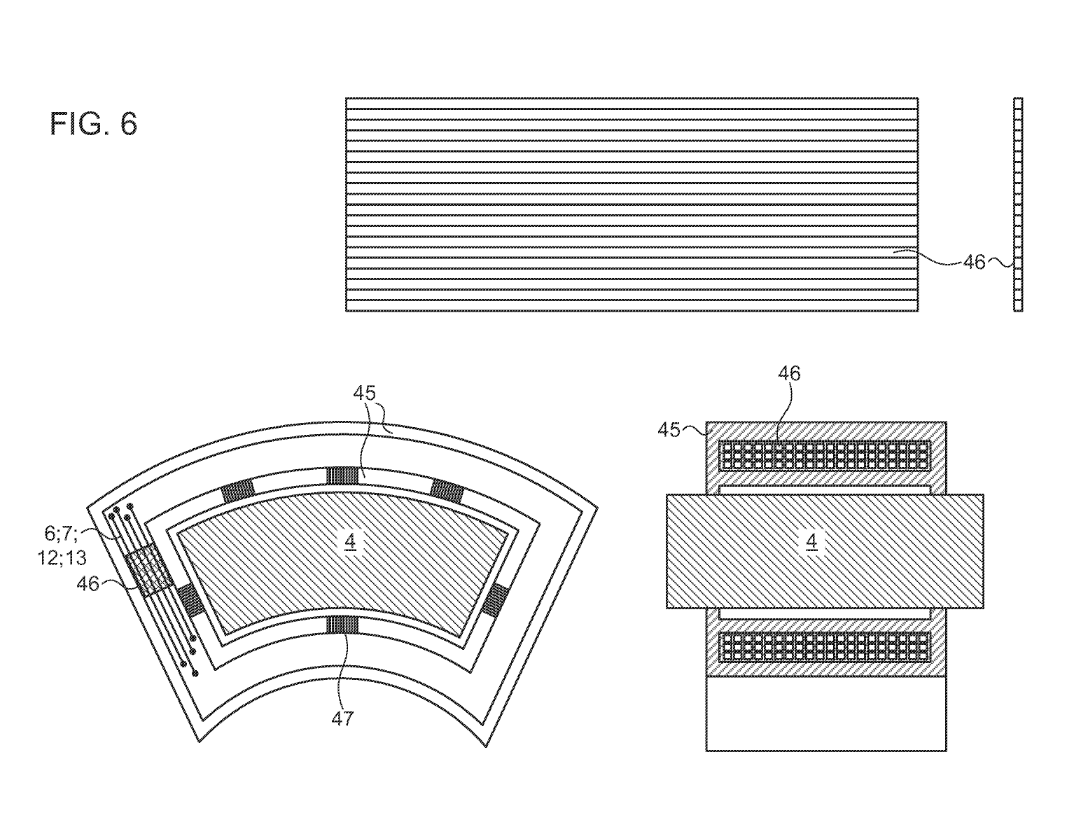

With regards to the electric motor assembly, in one embodiment of the invention the electric motor comprises features as seen in FIGS. 1-6. The machine comprises a main central axis (FIG. 1) and a rotor which comprises housing 3 (which can be comprised of any suitable material such as duralumin, antimagnetic steel or of any non iron metal) mounted to the axis 1 by toothed elements on the middle of the axis 1. The axis can be comprised of steel or any other suitable material. Housing 3 and axis 1 are associated to two cylindrical connector sleeves 2a and 2b. In one embodiment of the invention, the cylindrical sleeves are coupled by screws to housing 3. Associated to housing 3 is a plurality of electromagnets. Associated to housing 3 of the rotor are two electromagnets comprising elements 4, and 5 comprised of iron (iron structures), electrical coils 6 and 7 (coil structures) and carcass or housing 45 (FIG. 6). Associated to the edge of the iron structures 4 and 5 are rings 8a and 8b which prevent axial displacement of the elements associated to housing 3.

Positioned on the left and right side of the rotor are two stators. The stators comprise right housing 9dr and left housing 9st, right iron structures 10 dr and 11 dr, left iron structures 10st and 11st, right coils 12dr and 13dr, left coils 12st and 13st, right rings 14dr and 15dr, and left rings 16st and 17st (which can be comprised of any suitable strong material such as antimagnetic steel).

In one embodiment of the invention, above the rotor a connector element 18 (which can be comprised of any suitable strong material such as steel antimagnetic) is disposed between the right and left stators. Carcass 19 is associated to plate 27 by two or more supports 26. The right side of the machine is covered by a large cover 20 and small cover 22 (which can be comprised of any suitable material e.g. steel). The left side of the machine is covered by a large cover 21 and small cover 23. In spaces 24 and 25 in the right and left sides, respectively, are accommodated axial-radial bearings 24 and 25.

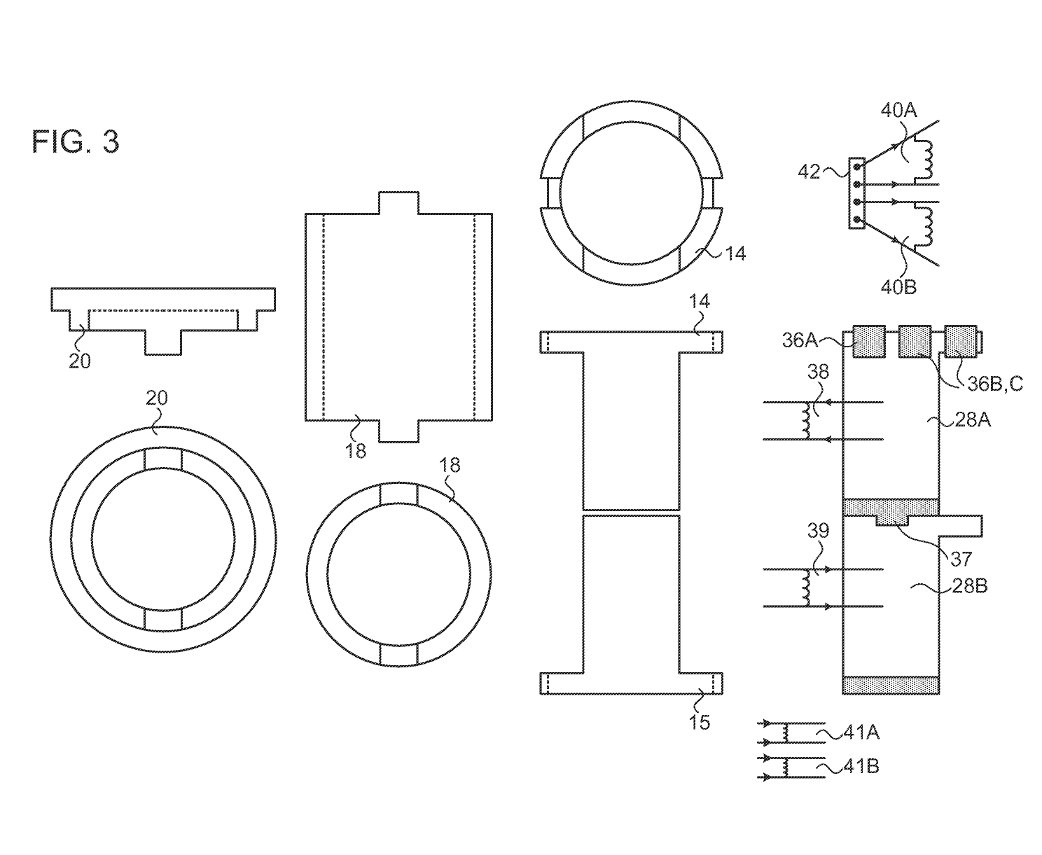

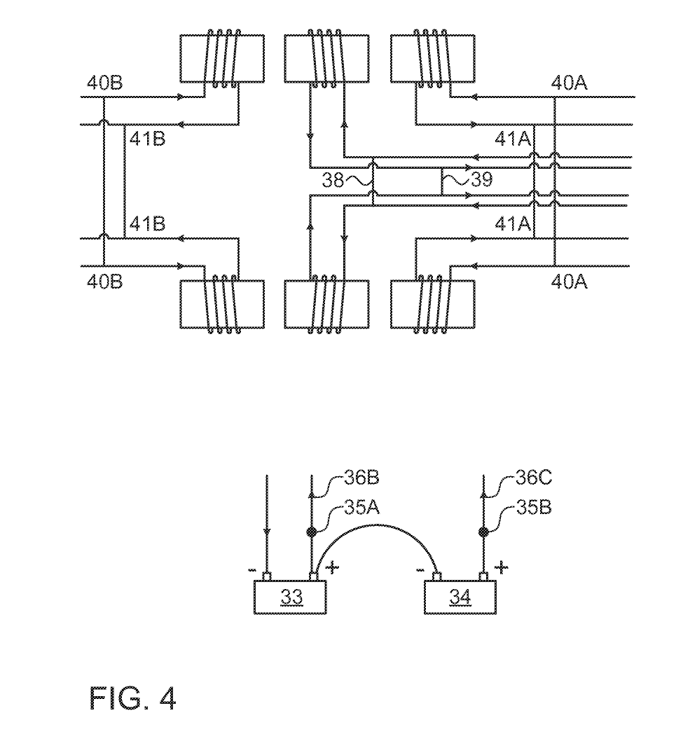

In one embodiment of the invention, positioned at the edge of axis 1 are electrical collector plates/lamellas 28a and 28b (comprised of a suitable material). Mounted on housings 29a and 29b (e.g. made of steel) are a plurality of graphite brush ports (30a, 30b, 30c and 31, respectively). The graphite brushes at the end of the ports are in connection with the surface of the collectors 28b and 28a, and said surface regularly rotates. 28a and 28b carry the electric current into the electromagnetic system in the rotor and in the two stators. Mounted on housings 29 are graphite brush ports 30a, 30b and 30c which are in constant contact with the surface of the collectors 28a and 28b (which continuously rotate) and transfer the electric current into the electromagnetic system in the rotors and in the stators. Mounted on housings 29b is graphite brush port 31 via which the electric current returns back from the rotor coils 6 and 7 and towards the electric current source 33. The electric current returning from the coils of the stators enters the negative terminal of the source 33 directly, without the need of the collector. The sources of electrical current 33 and 34 are connected in series transferring a high voltage to circuit 36c and a nominal voltage to circuit 36b (FIGS. 3 and 4).

In one embodiment of the invention, disposed in circuit 36c and 36b are current-diodes/rectifiers 35b and 35a, respectively (FIG. 4). The diodes prevent the return of current towards the positive terminal of the energy sources 34 and 33.

In one embodiment of the invention, each of the coil structures 6, 7, 12dr, 13dr, 12st 13st is arranged in a carcass or housing 45, comprising profile pages 46 made of aluminum, and packages of sheets of aluminum pages 47 which are electrically isolated on both surfaces (FIG. 6).

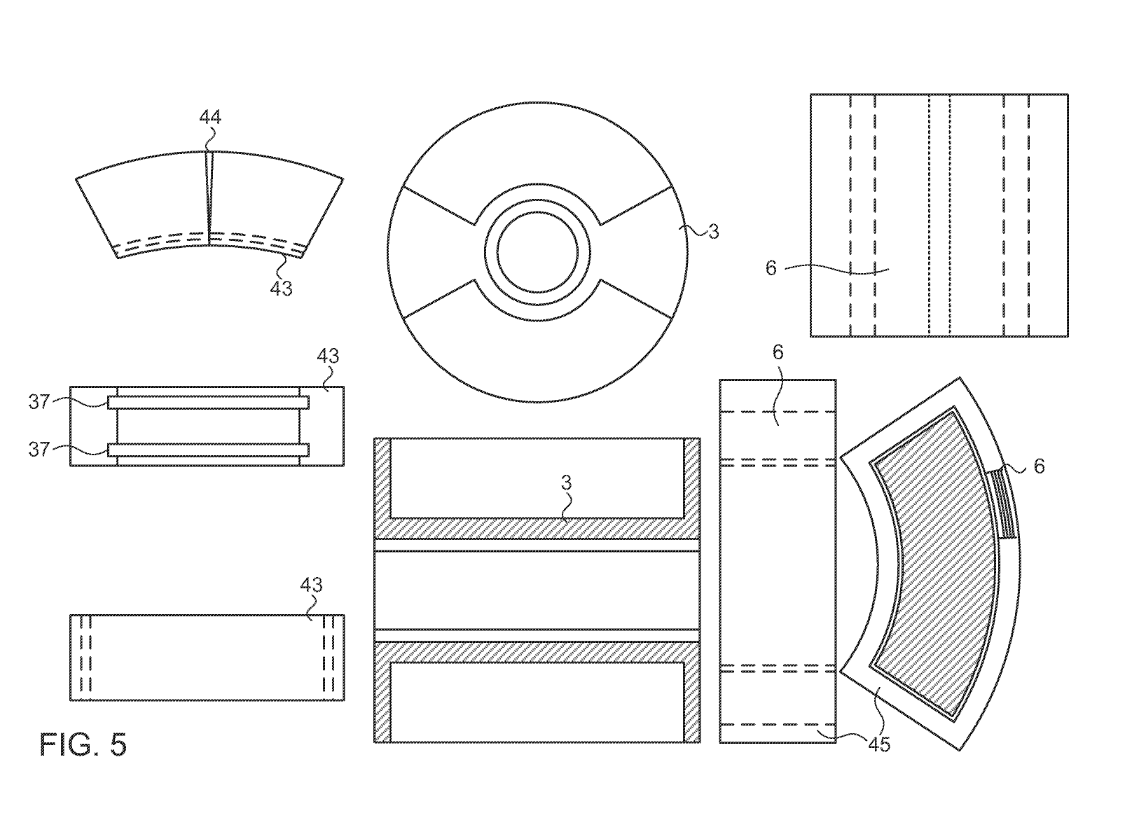

In FIG. 5 it is shown a carcass or housing 43 for assembling the iron structure comprised of electro-technical iron sheets and a profile 44.

With regards to the operation of the machine, the antagonistic polarization of the electromagnets above the rotor and above the two stators directs rotation of the rotor along axis 1. The electromagnets above the stators and above the rotor are energized by electric sources 33 and 34 (FIGS. 1, and 4) which are connected in series. The electric current flows from the electric sources to collectors 28a and 28b and to electric circuits 36b and 36c (FIGS. 3 and 4).

Via electric circuit 36c flows a maximal voltage E [V]. The voltage is equal to the sum of the voltages from the electric sources 33 and 34.

Lamella 28a, with the help of graphite brush 30c, can transfer the electrical current in two ways:
1—the current reaches the rotor coils via circuit 38 (FIGS. 3, 4).
2—the current reaches plate 42 which is made of a suitable metal (with the help of graphite brush 30a) and from there to the coils of the two stators (right and left) via circuits 40a and 40b (FIGS. 3, 4).

The electric current, causes simultaneous magnetization of each of the six electromagnets, two of the rotor 6 and 7, two of right stators 12dr and 13dr, and two of left stators 12st and 13st.

After a short period of time, which will be elaborated below, the graphite brush 30c disconnects from lamella 28a and the electric current continues to flow into collector 28a via graphite brush 30b and electric circuit 36b (FIGS. 1, 3 and 4).

From the collector 28a the electrical current is transferred by two ways:
1—the current reaches the rotor coils via circuit 38 (FIGS. 3 and 4).
2—the current arrives to plate 42 (FIG. 3), and from there it arrives to the coils of the two stators (right and left) via circuits 40a and 40b (FIGS. 3 and 4).

The period of time in which circuit 36c (FIGS. 3 and 4) works corresponds with the time in which the phenomena of self induction is present inside the electric coils and when the electrical current works on a variable regime from intensity=0 up to the final intensity.

In one embodiment of the invention, the period of time in which circuit 36b works parallels the time needed for half revolution of the rotor (180°) and is limited to a regime of continuous electrical current.

In one embodiment of the invention, the flow of electric current back from the coils is carried out as follows:

The current from the rotor coils flows back via electric circuit 39 (FIGS. 3 and 4), flows into lamella 28b (FIG. 1), after that into the graphite brush 31, and from there to the negative terminal of electrical source 33.

Flow of electric current back from the right and left stator coils directly to the negative terminal of electrical source 33 is mediated by electric circuits 41a and 41b (FIG. 3).

In one embodiment of the invention, the periodic interruption of the electric current from electric source 33 occurs every 180° of rotation of the rotor. This interruption occurs due to neutral contacts (FIG. 3, 32a and 32b) existing in a fixed position in the lamella 28a and lamella 28b (the interruption happens simultaneously when the electrical current enters and when the electrical current exits the collector). In the next 180° round of the rotor, lamella 28b initiates its activity by turning the polarization of rotor coils but by creating the same polarization in the stator coils.

The above operation is repeated in cycles. The power that is created in the rotor is transferred by axis 1 to different wheels, straight to the consumer.

The special electromagnets according to the invention can be used in any electric motor.

Non limiting examples of use of the electric motor according to the invention include use in cars, trains, trams, and helicopters. The electric motor according to the invention can be used to make electricity if connected with a dynamo.

In one embodiment of the invention, the structure and operation of the machine of the present invention solves satisfactorily the electromagnetic inertia problem (as generally described in points 1b-7b above) as follows:

1b—each electromagnet of the machine comprises an iron structure which is at least partially located inside a carcass 45 comprised of paramagnetic material (e.g. aluminum, duralumin). Inside the carcass 45 cavity an electric coil structure (e.g. 6 or 7) is placed.

The coil is assembled together with profile of sheets (46) made of paramagnetic material in such a way that the carcass 45 together with the coil 6 and the sheets 46 look like one block of metal with minimal volume of air inside the carcass 45 cavity (FIGS. 5 and 6).

Under these assembly conditions, the electrical current entering into the electric coil (in a regime of variable current) creates a variable magnetic field, which about 100% concentrates inside the iron structure.

Only a small amount of magnetic lines flow into the carcass 45 pocket present below the first line of the electric coil winding.

At the same time, two electric variable fields of self induction are created:
1—A slightly strong and main variable electric field that creates a variable magnetic field inside the iron structure, this variable electric field rotates around the iron structure, it cannot flow inside the carcass 45 cavity where the electric coil is positioned, and therefore can't have an effect on the electrons of the coil wires.
2—A slightly weak variable electric field is created inside the carcass 45 cavity, due to the weak variable magnetic field created below the first row of the coil (due to the variable magnetic lines that travels there). This variable electric field has a minimal effect on the electrons of the coil wires.

In view of points 1 and 2 above, the “self induction” process is significantly reduced. One can compare this reduction with significant reduction of a factor known as “inductance”. In spite that inductance does not change, it cannot have an effect on the coils.

2b) As illustrated in the drawings, in the electromagnets the supply path of electric current and exit path of electric current to and from the coils are arranged in pairs. For example, to the electric coils of the rotor 6 and 7, in the supply path of current in coils 6 and 7 and in the exit path of the current, there is connected an electric wire between the edges of the pair of coils. Under these assembly conditions, all the self-induced electric current inside coils 6 and 7 neutralize each other.

Similarly, these assembly conditions enable all the electric current self-induced inside the coils 12dr and 13dr and coils 12st and 13st neutralize each other.

This neutralization between pair of coils occurs also due to the fact that central circuits 36c and 36b are equipped with current diodes/rectifiers 35a and 35b which prevent flow of self-induced current in direction to the positive terminal of the current sources 33 and 34.

When the current interruption or pause from source 33, which may occurs every 180° rotation of the rotor of the machine, the self-induced current created are neutralized as above (when self-induced current is created when starting of the current).

3b—the velocity of the current variation di/dt [Amp/sec] is increased by the following method:

At initiation of the activity, the maximal velocity needed (and possible) is used from source 33 connected in series with source 34 and consequently resulting in increase of the contra-electromagnetic force −e[V] which significantly influences on the velocity of variability of the electric current −e/L=di/dt[Amp/sec].

After a short period of time in which the variation of the electric current ends according to: E=Ri−E[V], when “e”[V] turns to 0, all the coils continue to receive current with a nominal intensity [Amp], only from electric source 33 using circuit 36b.

4b) the following can be implemented regarding turbionari (eddy) current: The use of electro-technical iron which allow minimal possible losses [W/Kg]. The use of an amount of electrical current needed for inducing the required magnetization together with a certain additional supplement of current. Under these conditions the amount of additional current neutralizes the variable magnetic field which creates the turbionari current.

5b) due to the special arrangement of the electromagnets, any kind of mutual induction between the coils is not created, nor any kind of contra electromotor forces of mutual induction.

In view of the above solutions, the problem related to the magnetic self induction phenomena is satisfactorily solved. Along with these solutions, it is now practically possible to use the potential energy of the natural magnetic field present in iron for creating mechanic energy.

Advantageously, a electric motor according to the invention can create electric current if connected with an electric dynamo.

With regards to the power [Kw] which can be obtained from the machine according to the invention:

The power is a function of
A) Average force [N] that acts on the rotor
B) Average velocity [m/sec] of the rotor as follows;
   Force [N]×velocity [m/sec]=W

If desired, in order to obtain grater power [Kw] e.g., the following assemblies can be used:
a) A bigger group of rotor-stator can be used on the same central axis e.g.: 2 rotors and 3 stators; 3 rotors and 4 stators; and 4 rotors and 5 stators.
b) According to the size of the rotor diameter it is possible to mount a higher number of electromagnets e.g.: 4 electromagnets on the rotor and 2×4 on the stator; 6 electromagnets on the rotor and 2×6 on the stator; and 8 electromagnets on the rotor and 2×8 on the stator.
c) Also, it is possible to combine the above a) and b) approaches.

The electric motor according to the invention has also the following advantages: it uses a source of energy which does not pollute the environment, it uses a source of energy from the natural magnetic electric field of iron, is easy to operate, and the source of energy from the magnetic field is accessible and inexpensive. The source of energy from iron is non limited because iron is available everywhere. Also, the electric motor according to the invention can occupy a relative small space, can have a small weight it is easy to construct and to maintain.

The electric motor according to the invention is characterized in that it uses energy of electric field from electromagnets mounted in a group of rotors-stator in order to produce mechanic energy of rotation on the central axis of the machine.

This arrangement, allows a minimal time lapse for the simultaneous turning of the polarization in the group of electromagnets (depending on the needed objective).

In one embodiment of the invention, the turning of polarization of the electromagnets occurs every 180° rotation of the rotor of the machine and it is not accompanied by phenomena of self-induction due to the special structure or assembly of the machine.

In one embodiment of the invention, the iron structure of the electromagnets includes packages or boundless of electro-technical iron sheets having certain profile and with a polarization arranged in an order as the central axis (FIG. 5). The electromagnet is mounted inside of a metal block (non iron) comprising: Carcass 45 made of a suitable paramagnetic material (e.g. duralumin). In one embodiment of the invention, an electric coil structure comprised of cuprum wires is also present inside the carcass 45. In one embodiment of the invention, between the coil windings, during assembly, are placed aluminum sheets of a certain profile (FIG. 6, 46). Due to this special structure, the variable magnetic field produced inside the electromagnets concentrates inside the iron structure and the electric variable field of self induction cannot exert an effect to the coil of the electromagnet, since it cannot enter into the carcass cavity (45) where the coil is located. In view of the above, the velocity of the variation of the electrical current [Amp/sec] increases hundreds of times whereas the time needed for reaching the final intensity of I [Amp] correspondingly considerably decreases hundreds of times.

The carcass 45 is characterized in that it is made of paramagnetic material. The lower part of the carcass in all its length and its periphery comprises packs of sheets (FIG. 6, 47) of suitable paramagnetic material electrically insulated on its two surfaces and constructed as needed.

The source of electric current is arranged in two steps and is characterized in that:

In an initial stage when the electric current changes from 0 and reaches to a nominal current final level I=U/R two electrical source are used 33 and 34 which are connected in series. In view of that, the voltage E [V] is bigger than the nominal source 33, and therefore considerably increases the velocity of the variation of the electrical current −e/L [Amp/sec]. At the same time, decreases considerably the time needed for reaching the final intensity of I [Amp].

After the time that the variable current ends and the current become continuous, automatically, the circuit 36c stops its activity (that is connected to the maximal voltage E [V]), and initiates the activity of the circuit 36b that is connected only to the continuous source 33.

The configuration of the electric current which flows into the coils of the electromagnets is characterized in that:

The source of continuous electrical current 33 and 34 that are connected in series in two circuits:

circuit 36c (FIGS. 1 and 3) which transfers the electric current from the source 33+34 to the lamella 28a of the collector that rotates together with the central axis 1 with the help of the graphite brush 30c.

circuit 36b which transfers the electric current only from source 33 to the lamella 28a with the help of the graphite brush 30b, only after the contact between the electric circuit 36c and the lamella 28a ends.

From lamella 28a the current reaches the graphite brush 30a, and next the circuit 36a, to the metal plate 42, and to the coils of the two stators.

At the same time, from lamella 28a the current enters into the rotor coils via circuit 38.

The return of the electric current is carried out as follows:

From the rotor to the lamella 28b, with the help of electric circuit 39, to the graphite brush 31 and from there to the negative terminal of the 33 source.

From the stators to the circuit 41a, from there to circuit 41b, and from there to the negative terminal of the 33 source.

The technical arrangement with the objective to remove the electrical current self-induced which are created in the period of electric variable current is characterized in that:
a—Connected to each of the basic electric circuits 36c and 36b are electric diodes 35b and 35a which prevent return back of any kind of electricity into the positive terminal of the sources 33 and 34.
b—All electric circuits that enter into the coils of the electromagnets and all the circuits which exit from the coils are arranged in pairs (FIG. 4): 38 and 39 in the rotor, 40a and 41a in the right stator, 40b and 41b in the left stator.
c—Due to the arrangement in a) and b), all the self-induced current neutralize each other within each pair of coils.

The cylindrical connector sleeves 2a and 2b (FIG. 1) maintain the rotor between two stators from right and left side, and prevent the motion of the rotor in axial direction. A connector 18 is used maintain distances is mounted inside of carcass 19. The connector 18 is connected to the stators, by toothed axial elements present in both sides of the connection, and maintains the rotor in place between the two stators.

The covers 20 and 21 allow orienting the right and left stators, via to toothed axial elements present in axial position.

The sheets made from electro-technical iron 44 (FIG. 5) of the electromagnets have a geometrical form as needed.

The carcass 43, which holds the sheets 44 have together in the bottom side two channels (FIG. 5, 37) which allow assembly of the supports 3, 9dr, 9st, preventing movement in axial direction of the iron blocks (formed from iron pieces) 4, 5, 10dr, 11dr, 11st.

The collector of the machine are characterized in that they comprise two principal elements, 28a and 28b [made of a suitable material and between them are accommodated two electric neutral contact surface (FIG. 3, 32a and 32b)]. The collectors element 28a is in continuous contact with the graphite brushes 30a, 30b, and 30c during a time required for 180° rotation of the axis. During this contact, the electrical current is transferred in the direction to the rotor, right stators and left stators.

The collectors element 28b is in continuous contact with the graphite brush 31 during the time required for 180° rotation of the axis. During this contact, back electrical current is transferred from the coils of the rotor to the negative terminal of the electric source 33.

Every half rotation (180°), the lamella 28a exchanges places with lamella 28b and, consequently, polarization turns North-South only in the electromagnets of the rotor. In the stators, the polarization remains the same all the time.

Lamellas 28a and 28b, (having extension as shown in the Figs.) each temporarily come in contact with graphite brush 30c and by this the electric current enters from both of the electric sources 33 and 34 into the circuit 36c with a temporarily high voltage.

The invention relates also to a system that comprises a permanent magnet mounted on a rotor and electromagnets according to the invention mounted on the stators.

A permanent magnet mounted on the stators and electromagnets according to the invention mounted on the rotor.

Electromagnets with a different geometric shape from that shown in the examples of the invention but having the specific elements of the invention which are reflected in the claims of this invention are considered part of this invention.

What is claimed is:

1. An electric motor comprising:
a stator provided with at least two electromagnets; and
a rotor provided with at least two electromagnets.

2. The electric motor of claim 1, wherein the polarization of the electromagnets is changed in a way to reduce self-induction.

3. The electric motor of claim 1, wherein each electromagnet includes:
a coil wire structure;
an iron structure; and
paramagnetic material separating at least segments of the wire coils from each other and the coil wire structure from the iron structure.

4. The electric motor of claim 1, further comprising:
two voltage sources connected in series;
wherein the series connected voltages sources are arranged to initiate a rotation cycle of the rotor and only one of the voltage sources is arranged to drive the rotor for the majority of the rotation cycle.

5. The electric motor of claim 1 further comprising:
a first electrical path connecting the leads to one polarity of the at least two electromagnets of the stator;
a second electrical path connecting the leads to the other polarity of the at least two electromagnets of the stator;
a third electrical path connecting the leads to the one polarity of the at least two electromagnets of the rotor; and
a fourth electrical path connecting the leads to the other polarity of the at least two electromagnets of the rotor.

6. An electromagnet comprising:
a coil wire structure including a plurality of coil wires;
an iron structure; and
paramagnetic material that separates (1) the coil wire structure from the iron structure and (2) segments of the coil wires from each other.

7. A method for producing mechanical energy of rotation using electromagnetic energy comprising the steps of:
providing two stators each with at least two electromagnets;
providing a rotor with at least two electromagnets;
providing two voltage sources connected in series;
providing electric path for supplying current from the voltage sources to the electromagnets and driving current back from the electromagnets, and
energizing the electromagnets and creating antagonistic polarization of the electromagnets of the stators and the rotor using the voltage sources,
wherein the polarization of the electromagnets of the rotor changes every half rotation of a cycle;
wherein the series connected voltage sources are arranged to initiate a rotation cycle of the rotor and only one of the voltage sources is arranged to drive the majority of the rotation cycle; and
wherein the polarization is changed in a way to reduce self-induction.
